(19) United States
(12) Patent Application Publication
(10) Pub. No.: US 2025/0292698 A1
(43) Pub. Date: Sep. 18, 2025

(54) DATA CONVERSION APPARATUS, DATA CONVERSION METHOD, AND DATA CONVERSION PROGRAM

(71) Applicant: Hitachi, Ltd., Tokyo (JP)

(72) Inventors: Yuta KOREEDA, Tokyo (JP); Ekant Muljibhai AMIN, Tokyo (JP)

(73) Assignee: Hitachi, Ltd., Tokyo (JP)

(21) Appl. No.: 18/967,005

(22) Filed: Dec. 3, 2024

(30) Foreign Application Priority Data
Mar. 13, 2024 (JP) 2024-038713

(51) Int. Cl. G09B 7/06; G06F 40/166

(52) U.S. Cl. CPC G09B 7/06; G06F 40/166

(57) ABSTRACT

A data conversion apparatus including a processor that executes a program and a storage device that stores the program performs input processing of receiving a plurality of options and a first question sentence where one of the plurality of options is a correct answer, conversion processing of converting, based on the plurality of options and the first question sentence received by the input processing, the first question sentence into a second question sentence in a format different from a format of the first question sentence, and output processing of outputting the second question sentence converted by the conversion processing and the plurality of options.

### REFERENCE TO RELATED APPLICATIONS

The present application claims priority from Japanese patent application No. 2024−38713 filed on Mar. 13, 2024, the content of which is hereby incorporated by reference into this application.

### BACKGROUND OF THE INVENTION

### 1. Field of the Invention

The present invention relates to a data conversion apparatus, a data conversion method, and a data conversion program for converting data.

### 2. Description of Related Art

In recent years, there has been significant development in language models represented by Generative Pretrained Transformer (GPT) and Bidirectional Encoder Representations from Transformers (BERT). These language models are also referred to as foundation models or the like, and are used for various downstream tasks such as text generation, document classification, translation, image captioning, and grammatical parsing.

A language model may be evaluated by a downstream task as an integrated system including external knowledge utilization, preprocessing and postprocessing, and additional supervised learning. However, large cost is required to construct the integrated system, and completeness of parts other than the language model has a large impact on a performance of the downstream task. Therefore, it is desirable to enable standalone evaluation of the language model.

At present, there are evaluation data and evaluation methods specifically created for the standalone evaluation of the language model. In general domains, the standalone evaluation of the language model is available using the evaluation data and the evaluation methods. However, for example, when a new language model is created for a specific domain, the evaluation data and the evaluation methods alone are insufficient.

Since the evaluation data and the evaluation methods are created by humans, cost increases when evaluation data and evaluation methods for the specific domain are constructed using the same procedure. Meanwhile, even in the specific domain, there may be a test or an exercise question for humans. However, in general, the language model is statistically constructed through a fill-in-the-blank question or a completion question of text, while a question for humans may also include a multiple-choice question. Therefore, in order to evaluate the language model through the question for humans, it is necessary to incorporate the external knowledge utilization, the preprocessing and postprocessing, the additional supervised learning, and the like into the language model as described above. Therefore, it is difficult to perform the standalone evaluation of the language model.

NPL 1 below discloses an evaluation method for a language model. NPL 2 below discloses an evaluation method for a language model based on end completion. NPL 3 below discloses a machine learning system that formulates a task as prediction of a transition label between text fragments by mapping the text fragments to a tree.

### CITATION LIST

### Non Patent Literature

[NPL 1] Alec Radford, Jeffrey Wu, Rewon Child, David Luan, Dario Amodei, Ilya Sutskever. 2018. Language Models are Unsupervised Multitask Learners. OpenAI Blog.
[NPL 2] Rowan Zellers, Ari Holtzman, Yonatan Bisk, Ali Farhadi, and Yejin Choi. 2019. HellaSwag: Can a Machine Really Finish Your Sentence?. In Proceedings of the 57th Annual Meeting of the Association for Computational Linguistics, pages 4791−4800, Florence, Italy. Association for Computational Linguistics.
[NPL 3] Yuta Koreeda and Christopher Manning. 2021. Capturing Logical Structure of Visually Structured Documents with Multimodal Transition Parser. In Proceedings of the Natural Legal Language Processing Workshop 2021, pages 144-154, Punta Cana, Dominican Republic. Association for Computational Linguistics.

### SUMMARY OF THE INVENTION

It is known that the evaluation method based on a four-option question disclosed in NPL 1 depends on a method for structuring a question sentence (a method for creating a prompt), and currently, various performances have been reported even for the same language model. The evaluation method disclosed in NPL 2 is an evaluation method that is manually constructed over time, and no apparatus or method for constructing the evaluation method is disclosed.

An object of the invention is to optimize a format of a question sentence for an evaluation target.

A data conversion apparatus according to an aspect of the invention disclosed in the present application includes: a processor configured to execute a program; and a storage device configured to store the program, in which the processor performs input processing of receiving a plurality of options and a first question sentence where one of the plurality of options is a correct answer, conversion processing of converting, based on the plurality of options and the first question sentence received by the input processing, the first question sentence into a second question sentence in a format different from a format of the first question sentence, and output processing of outputting the second question sentence converted by the conversion processing and the plurality of options.

According to a representative embodiment of the invention, it is possible to optimize a format of a question sentence for an evaluation target. Problems, configurations, and effects other than those described above will become apparent in the following description of embodiments.

### BRIEF DESCRIPTION OF THE DRAWINGS

FIG. 1 is a block diagram showing a hardware configuration example of a data conversion apparatus according to a first embodiment.

FIG. 2 is a block diagram showing a functional configuration example of the data conversion apparatus according to the first embodiment.

FIG. 3 is a flowchart showing a procedure example of input question structuring processing by an input question structuring unit according to the first embodiment.

FIG. 4 shows an example of input question data.

FIG. 5 shows an example of structured input question data.

FIG. 6 is a flowchart showing a procedure example of question format conversion processing by a question format conversion unit according to the first embodiment.

FIG. 7 shows an example of a prompt template.

FIG. 8 shows an example of a prompt.

FIG. 9 is a flowchart showing a detailed processing procedure example of text generation (step S602).

FIG. 10 shows an example of a token dictionary.

FIG. 11 shows an example of generated text.

FIG. 12 shows an example of end completion question data.

FIG. 13 is a block diagram showing a functional configuration example of a data conversion apparatus according to a second embodiment.

FIG. 14 is a flowchart showing a detailed processing procedure example of generated score calculation processing by a generated score calculation unit.

FIG. 15 is a flowchart showing a detailed processing procedure example of generated score calculation (step S1404) according to the second embodiment.

FIG. 16 shows an example of an end completion question prediction result.

FIG. 17 is a flowchart showing a procedure example of question format conversion processing by a question format conversion unit according to a third embodiment.

FIG. 18 shows an example of a first REST query.

FIG. 19 shows an example of a first response.

FIG. 20 is a flowchart showing a detailed processing procedure example of generated score calculation (step S1404) according to the third embodiment.

FIG. 21 shows an example of a second REST query.

FIG. 22 shows an example of a second response.

FIG. 23 is a flowchart showing a procedure example of question format conversion processing by a question format conversion unit according to a fourth embodiment.

FIG. 24 shows an example of syntactic parsing.

FIG. 25 shows an example of an input question sentence information summary.

### DESCRIPTION OF THE INVENTION

Hereinafter, embodiments of the invention will be described with reference to the drawings. The invention is not to be construed as being limited to the description of the embodiments described below. It will be easily understood by those skilled in the art that a specific configuration can be changed without departing from the spirit or scope of the invention. In the configurations of the invention described below, the same or similar configurations or functions are denoted by the same reference signs, and a redundant description thereof will be omitted.

Notations “first”, “second”, “third”, and the like in the present specification and the like are provided to identify components, and do not necessarily limit the number or the order. In order to facilitate understanding of the invention, a position, a size, a shape, a range, and the like of each configuration shown in the drawings and the like may not represent an actual position, size, shape, range, and the like. Therefore, the invention is not limited to the position, the size, the shape, the range, and the like disclosed in the drawings.

### First Embodiment

A data conversion apparatus according to a first embodiment will be described with reference to the drawings. The data conversion apparatus is a computer that converts existing question data used for an existing evaluation test for humans into question data in a completion format suitable for language model evaluation. In the first embodiment, processing of receiving a set of four-option questions in English and converting the set of questions into a completion question sentence suitable for language model evaluation is described as an example. The completion question sentence is an explanatory sentence in a completion format with a missing part where a sentence is to be completed by filling in a correct answer among a plurality of options.

For example, when the question sentence is “Which of the following defines the guarantee of the levels of availability?” and a plurality of options thereof are
a.NDA
b.SLI
c.SLA
d.SLO,
the completion question sentence is an explanatory sentence in a completion format with a missing part where a sentence is to be completed by filling in a correct answer among the plurality of options
a.NDA
b.SLI
c.SLA
d.SLO,
that is, “The guarantee of the levels of availability is defined by”. This completion question sentence is referred to as an end completion question sentence since a correct answer portion is missing from an end of the sentence.

A target input question is not limited to English or a natural language, and may be in any format as long as humans can understand, including natural languages from different language families such as Japanese and Chinese, a programming language or markup language such as Java (registered trademark), C language, Mathematica language, and HTML, a domain-specific language (DSL) constructed by a user, a figure, a table, an audio, a numerical sequence, a mathematical formula, and a combination thereof.

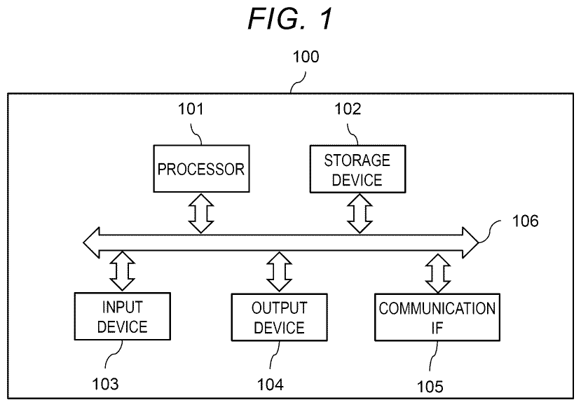

### FIG. 1 Hardware Configuration Example of Data Conversion Apparatus

FIG. 1 is a block diagram showing a hardware configuration example of the data conversion apparatus according to the first embodiment. A data conversion apparatus 100 includes one or more computers. The data conversion apparatus 100 includes a processor 101, a storage device 102, an input device 103, an output device 104, and a communication interface (communication IF) 105. The processor 101, the storage device 102, the input device 103, the output device 104, and the communication IF 105 are connected to one another by a bus 106. The processor 101 controls the data conversion apparatus 100. The storage device 102 is a work area of the processor 101. The storage device 102 is a non-transitory or transitory recording medium that stores various programs or data. Examples of the storage device 102 include a read only memory (ROM), a random access memory (RAM), a hard disk drive (HDD), and a flash memory. The input device 103 inputs data. Examples of the input device 103 include a keyboard, a mouse, a touch panel, a numeric keypad, a scanner, a microphone, and a sensor. The output device 104 outputs data. Examples of the output device 104 include a display, a printer, and a speaker. The communication IF 105 is connected to a network to transmit and receive data.

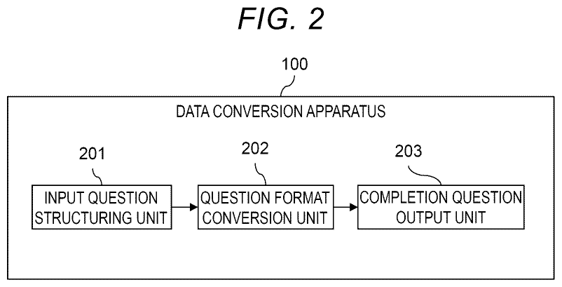

### FIG. 2 Functional Configuration Example of Data Conversion Apparatus 100

FIG. 2 is a block diagram showing a functional configuration example of the data conversion apparatus 100 according to the first embodiment. The data conversion apparatus 100 includes an input question structuring unit 201, a question format conversion unit 202, and a completion question output unit 203. Specifically, for example, the input question structuring unit 201, the question format conversion unit 202, and the completion question output unit 203 are functions implemented by causing the processor 101 to execute a program stored in the storage device 102 shown in FIG. 1.

The input question structuring unit 201 receives input of question data including one or more questions, and divides each piece of question data into question text and options. The question format conversion unit 202 receives each piece of structured question data and creates question data in a completion format. The completion question output unit 203 outputs the question data in the completion format.

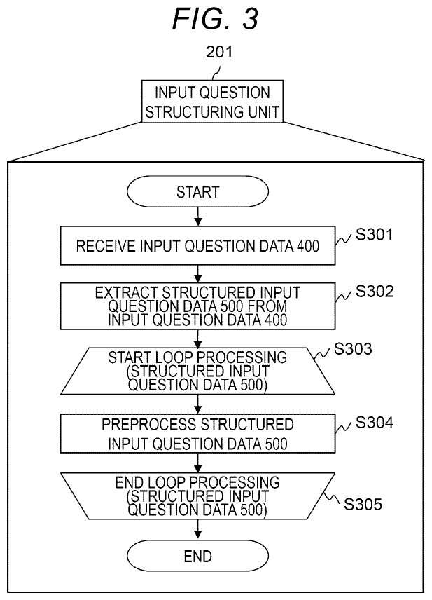

### FIGS. 3 to 5 Input Question Structuring Processing

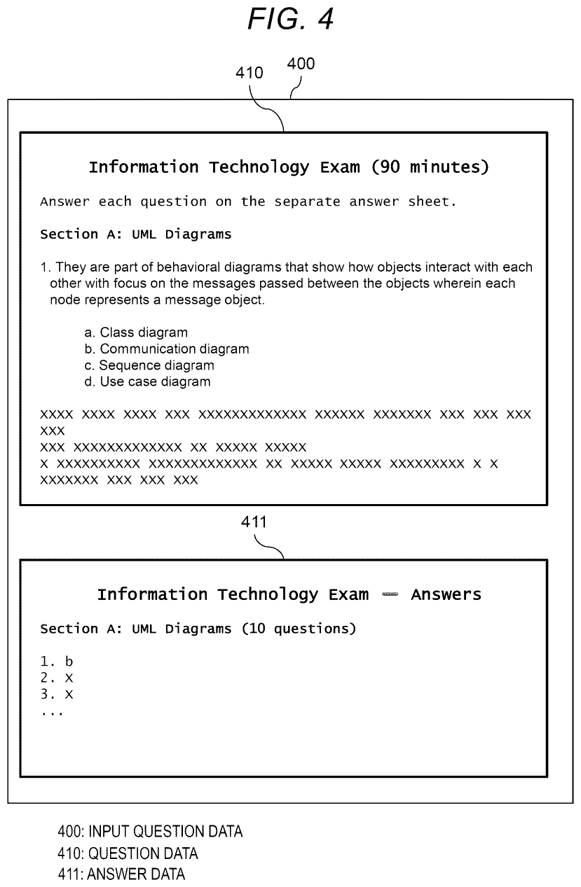

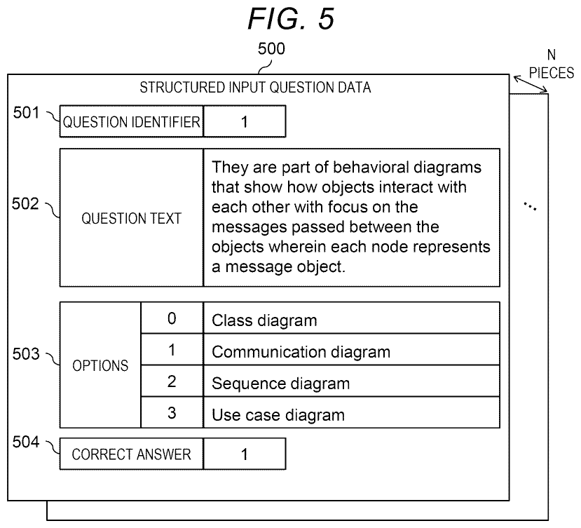

FIG. 3 is a flowchart showing a procedure example of input question structuring processing by the input question structuring unit 201 according to the first embodiment. FIG. 4 shows an example of input question data. FIG. 5 shows an example of structured input question data.

### Step S301

The input question structuring unit 201 receives input of input question data 400. The input question data 400 includes one or more multiple-choice questions. The input question data 400 may include a plurality of documents such as a document including question data 410 and a document including answer data 411, or may include the question data 410 and the answer data 411 in one document. The input question data 400 may include an element other than the question and the answer, such as an explanatory sentence or an instruction, or may mostly be an element other than the question and the answer, such as that can be seen in example sentences in a textbook.

In FIG. 4, the question data 410 is
“They are part of behavioral diagrams that show how objects interact with each other with focus on the messages passed between the objects wherein each node represents a message object.
a. Class diagram
b. Communication diagram
c. Sequence diagram
d. Use case diagram”,
which is a question sentence in a declarative sentence format whose correct answer portion is expressed with a demonstrative pronoun “They” at the beginning of the sentence.

A medium where the input question data 400 is represented may be paper, oral presentation, encrypted data, and the like, and it will be easily understood by those skilled in the art that such a medium can be digitized by means of Optical Character Recognition/Reader (OCR), voice recognition, decryption, and the like. The input question data 400 represented in an electronic medium may be plain text as shown in the first embodiment as an example, or may be a table, a formatted document, a Portable Document Format (PDF) document, an Extensible Markup Language (XML) document, or the like, as long as the input question data 400 can be processed using an existing technology, as will be easily understood by those skilled in the art.

Even when the input question data 400 includes a diagram or an image, the input question data 400 can be processed without departing from the scope of the first embodiment by using Layout Language Model (LayoutLM), GPT−4V, or the like, which is easily understood by those skilled in the art.

Step S302 The input question structuring unit 201 extracts one or more pieces of structured input question data 500 from the input question data 400. The structured input question data 500 includes a question identifier 501, question text 502, options 503, and a correct answer 504. The question identifier 501 is identification information for uniquely specifying the question text 502. The question text 502 is a character string indicating a question. The question text 502 may be an interrogative sentence that asks which of a plurality of options 503 is a correct answer or a declarative sentence that instructs any of the plurality of options 503. In the example in FIG. 5, a declarative sentence is used. The options 503 are a plurality of answer candidates for the question text 502. The correct answer 504 is an answer candidate selected from the options 503.

The input question structuring unit 201 scans each line in the question data 410 and extracts the question text 502 by treating a line that satisfies a first regular expression /∧([1−9][0−9]*)¥ [symbol] / in Perl syntax as a start portion of the question [symbol] text 502 and treating a line immediately before a line that satisfies a regular expression /∧ [symbol] +[a-z]¥./ as an endpoint of the question text 502.

The input question structuring unit 201 stores, as the question identifier 501, a character string stored in a first match group of the first regular expression (a character string that matches [1−9][0−9]* enclosed in parentheses).

The input question structuring unit 201 stores, in options 503, a character string stored in the first match group of a line [symbol] that matches a regular expression /∧ [symbol] +[a-z]¥. [symbol] ?(.*)$/ in the Perl syntax (a character string matching.* enclosed in parentheses) among lines from one piece of question text 502 to a next piece of question text 502.

The input question structuring unit 201 also performs the same scan on the answer data 411, and for each line that matches a regular expression /∧ [symbol] ([1−9][0−9]*)¥. [symbol] *([a-z])/ in the Perl syntax, stores a character string stored in the first match group (a character string matching [1−9][0−9]* enclosed in parentheses) in the correct answer 504 in the structured input question data 500 matching the question identifier 501, and stores a count of the options 503 matching a character string stored in a second match group (a character string matching [a-z]enclosed in parentheses).

The processing in step S302 may be implemented, according to a format of the input question data 400, by extraction processing based on different regular expressions, extraction processing based on a rule base, extraction processing based on machine learning, or a combination thereof as in NPL 3.

In step S302, when there is structured input question data 500 in which one or more of the question identifier 501, the question text 502, the option 503, and the correct answer 504 are missing, inconsistent, or duplicated due to incompleteness of the input question data 400 and incompleteness of the extraction processing, the processing of step S302 may include processing of removing the structured input question data 500 or requesting the user to correct the structured input question data 500.

### Step S303

The input question structuring unit 201 starts loop processing on the structured input question data 500 (step S303). Specifically, for example, the input question structuring unit 201 selects unselected structured input question data 500.

### Step S304

The input question structuring unit 201 performs preprocessing on the selected structured input question data 500. In the preprocessing (step S304), the input question structuring unit 201 deletes trailing and leading space characters from the question text 502 and normalizes spaces. The input question structuring unit 201 may also perform Unicode normalization or correction of OCR conversion errors.

### Step S305

The input question structuring unit 201 determines whether there is unselected structured input question data 500. When it is determined that there is unselected structured input question data 500, the processing returns to step S302. When it is determined that there is no unselected structured input question data 500, the input question structuring unit 201 ends the input question structuring processing of the structured input question data 500.

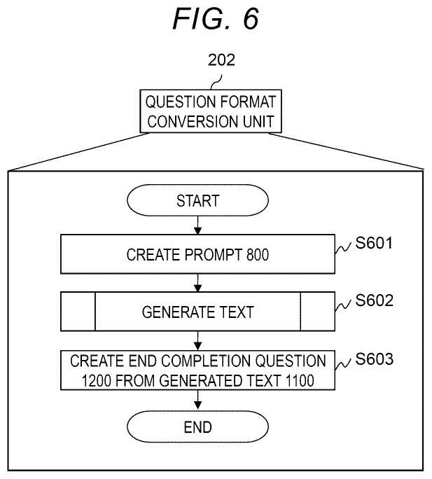

### FIGS. 6 to 8 Question Format Conversion Processing

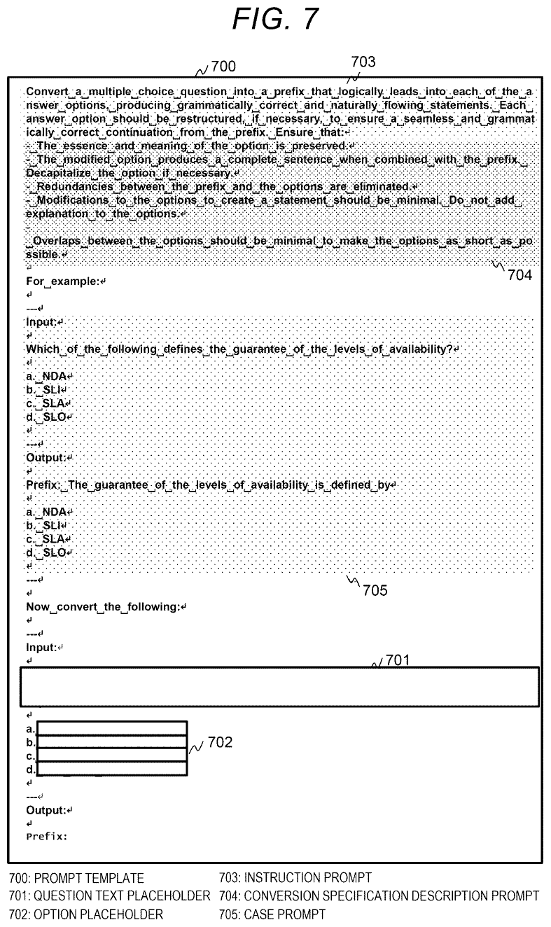

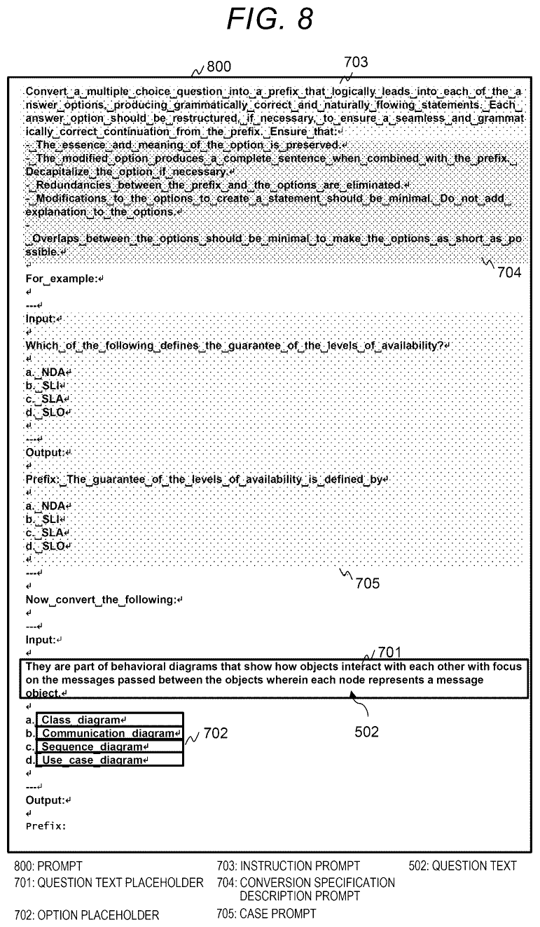

FIG. 6 is a flowchart showing a procedure example of question format conversion processing by the question format conversion unit 202 according to the first embodiment. FIG. 7 shows an example of a prompt template. FIG. 8 shows an example of a prompt. The question format conversion unit 202 performs the processing of step S601 to step S603 for each piece of structured input question data 500.

### Step S601

The question format conversion unit 202 combines the question text 502 with a prompt template 700 to create a prompt 800, which is an instruction sentence for generating question data in a completion format.

As shown in FIG. 7, the prompt template 700 includes a question text placeholder 701, an option placeholder 702, an instruction prompt 703, a conversion specification description prompt 704, and a case prompt 705.

The question text placeholder 701 is an area where the question text 502 is set. The option placeholder 702 is an area where the option 503 is set. The instruction prompt 703 is a character string indicating a sentence describing an instruction for conversion in a natural language. The conversion specification description prompt 704 is a character string indicating a sentence that describes a detailed specification of conversion in a natural language. In particular, the conversion specification description prompt 704 defines that the generated question data in the completion format is to be a declarative sentence to be ended with the option 503.

The case prompt 705 is an example of input and output formats. The case prompt 705 shows, as an example of an input format, an interrogative sentence that asks which of the plurality of options 503 is the correct answer to the question text 502

“Which of the following defines the guarantee of the levels of availability?”
and options thereof
“a. [symbol] DA
b. [symbol] SLI
c. [symbol] SLA
d. [symbol] SLO”, and
shows, as an example of an output format, an explanatory sentence in a completion format with a missing part to be completed by filling in the correct answer (completion question sentence)
“The guarantee of the levels of availability is defined by” and options thereof
“a. [symbol] NDA
b. [symbol] SLI
c. [symbol] SLA
d. [symbol] SLO”. Therefore, according to the input format with reference to the case prompt 705, the user may input the question text 502 to the question text placeholder 701 and input the option 503 to the option placeholder 702.

The question format conversion unit 202 stores the question text 502 in the question text placeholder 701, stores the option 503 in the option placeholder 702, and thus creates the prompt 800. If it is defined in the prompt template 700 that the generated question data in the completion format is required to end with the option 503, any content tailored to a field, a language, and other characteristics of the question text 502 may be contained.

The prompt template 700 does not necessarily have the above-described configuration as long as the prompt template 700 is oriented to generate the question data in the completion format using the question text 502, and may include any content according to the field, the language, and the other characteristics of the question text 502. Such information may be received separately from the user through a dialogue question, a setting file, or the like.

### Step S602

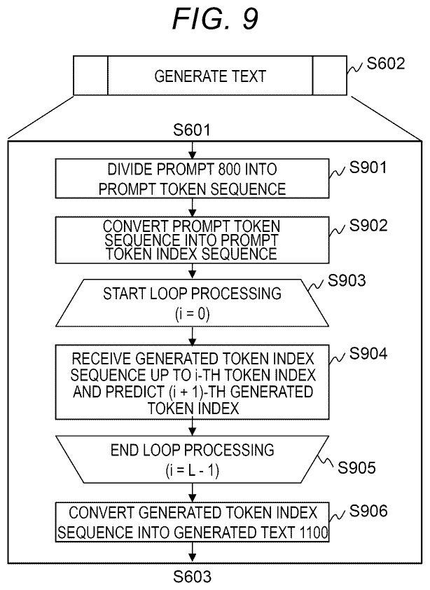

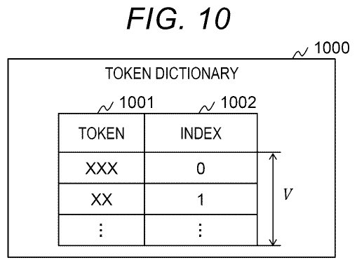

The question format conversion unit 202 generates text based on the prompt 800. The text generation (step S602) will be described with reference to FIGS. 9 and 10.

### FIG. 9 Text Generation (Step S602)

FIG. 9 is a flowchart showing a detailed processing procedure example of the text generation (step S602).

### Step S901

The question format conversion unit 202 divides the prompt 800 into a prompt token sequence including one or more tokens. The “token” generally means a minimum unit constituting a programming language such as a variable name, a reserved word, and an operator. In the first embodiment, division may be performed in units other than the “token” in the programming language, such as byte pair encoding.

### Step S902

The question format conversion unit 202 converts the prompt token sequence into a prompt token index sequence {t₀, t₁, . . . , t(P−1)} including P integers using a token dictionary.

### FIG. 10 Token Dictionary

FIG. 10 shows an example of the token dictionary. A token dictionary 1000 is information that associates a token 1001 with an index 1002. The index 1002 is identification information for uniquely specifying the token 1001. The token dictionary 1000 includes V entries (V is an integer of 1 or more).

Referring back to FIG. 9, the question format conversion unit 202 is implemented by matching each token constituting the prompt token sequence with the token 1001 in the token dictionary 1000 and acquiring the index 1002 matching the matched token 1001. When there is no token 1001 that matches the token, the token is associated with a predetermined index 1002.

### Step S903

The question format conversion unit 202 starts loop processing of a variable i. The variable i is set to 0 as an initial value.

### Step S904

The question format conversion unit 202 predicts an (i+1)-th generated token index using a probability distribution model for a token index sequence, such as GPT. The question format conversion unit 202 inputs the prompt token index sequence and the generated token index sequence up to an (i−1)-th generated token index into the probability distribution model, and calculates a probability distribution p(xi|θ, t₀, t₁, . . . , t(P−1), x₀, x₁, . . . , x(i−1)) of an i-th generated token index xi. Here, θ is a setting value (parameter) of the probability distribution model.

The question format conversion unit 202 obtains the generated token index with a maximum probability value of the probability distribution p(xi|θ, t₀, t₁, . . . , t(P−1), x₀, x₁, . . . x(i−1)) as the i-th generated token index.
argmaxxi p(xi|t₀, t₁, . . . , t(P−1), x₀, x₁, . . . , x(i−1))

Instead of selecting the token index with the maximum probability value, the question format conversion unit 202 may perform sampling based on the probability distribution p(xi|θ, t₀, t₁, . . . , t(P−1), x₀, x₁, . . . , x(i−1)) or select the token index using beam search or the like.

The probability distribution model may be implemented by a model based on a Transformer architecture such as T5 or Llama-2, a model based on recursive computation such as Long Short-Term Memory (LSTM) or Receptance Weighted Key Value (RWKV), or a model based on distributed computing such as GShard.

The above-described probability distribution model may be a model that learns word probability distribution by self-supervised learning using various documents, or a model trained with supervised learning based on a corpus including a pair of a prompt and end completion question data created manually or mechanically. If an input token index can be generated based on an input token index sequence, the requirement of the probability distribution may not be necessarily satisfied.

### Step S905

The question format conversion unit 202 determines whether the i-th generated token index is a token index indicating an endpoint of a document, and whether the variable i satisfies i=L−1 (L is a predetermined number of generated tokens L).

When it is determined that the condition is not satisfied, that is, when the i-th generated token index is not the token index indicating the endpoint of the document and the variable i does not satisfy i=L−1, the question format conversion unit 202 increments the variable i, and the processing returns to step S904.

When it is determined that the condition is satisfied, that is, when the i-th generated token index is the token index indicating the endpoint of the document, or when the variable i satisfies i=L−1, the question format conversion unit 202 ends the loop processing of the variable i, and the processing proceeds to step S906.

### Step S906

The question format conversion unit 202 converts a generated token index sequence {x₀, x₁, . . . , x(L−1)} into generated text. Specifically, for example, the question format conversion unit 202 matches each token index constituting the generated token index sequence {x₀, x₁, . . . , x(L−1)} with the index 1002 in the token dictionary 1000.

The question format conversion unit 202 reads the token 1001 associated with the matched index 1002 from the token dictionary 1000 and acquires a generated token sequence. The question format conversion unit 202 generates the generated text by combining acquired generated token sequences, and the processing proceeds to step S603.

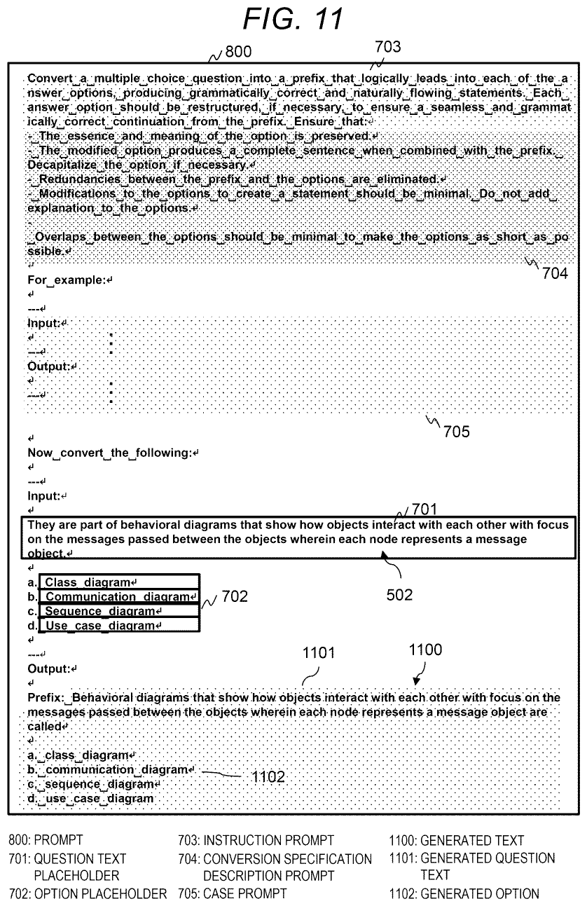

### FIG. 11 Generated Text

FIG. 11 shows an example of the generated text. The generated text 1100 includes a generated question text 1101 and a generated option 1102. The generated text 1100 is stored in the prompt 800.

Instead of performing the text generation by the data conversion apparatus 100 (step S602), the data conversion apparatus 100 may transmit the prompt created in step S601 to a language model implemented on an external computer. In this case, the language model implemented on the external computer performs the processing shown in FIG. 9 to generate the generated text 1100. Then, the data conversion apparatus 100 receives the generated text 1100 generated by the language model implemented on the external computer.

### Step S603

Referring back to FIG. 6, the question format conversion unit 202 creates end completion question data from the generated text 1100.

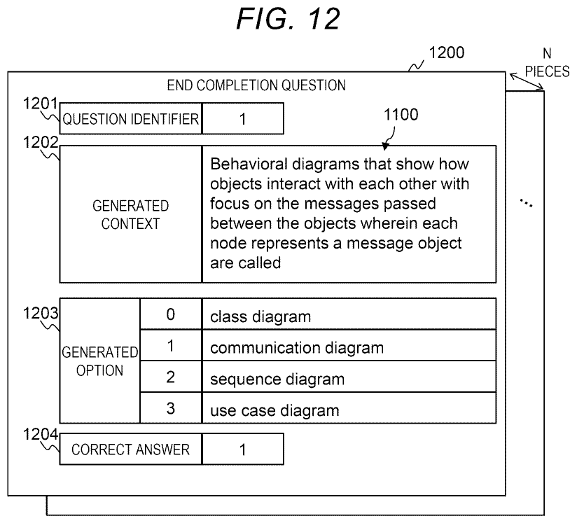

### FIG. 12 End Completion Question Data

FIG. 12 shows an example of the end completion question data. End completion question data 1200 includes a question identifier 1201, a generated context 1202, a generated option 1203, and a correct answer 1204.

A value of the question identifier 501 in the structured input question data 500 is set in the question identifier 1201. The generated question text 1101 is set in the generated context 1202. The generated option 1102 is set in the generated option 1203. A value of the correct answer 504 is set in the correct answer 1204.

The end completion question data 1200 is output from the completion question output unit 203. Specifically, for example, the completion question output unit 203 displays the end completion question data 1200 on a display, which is an example of the output device 104, outputs the end completion question data 1200 to a printer for printing, or transmits the end completion question data 1200 to the outside via the communication IF 105.

According to the first embodiment, the data conversion apparatus 100 constructs data suitable for language model evaluation from the existing evaluation test for humans, thereby enabling standalone evaluation of the language model without the need to manually create evaluation data exclusively for the language model.

### Second Embodiment

Next, a second embodiment will be described. In the second embodiment, processing of receiving the set of four-option questions in English in the first embodiment and converting the set of four-option questions into end completion questions suitable for evaluating the language model is described as an example. In the second embodiment, differences from the first embodiment will be mainly described, and thus descriptions of the same parts as those in the first embodiment will be omitted.

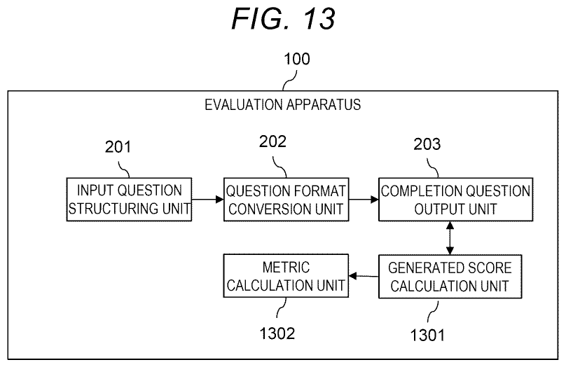

### FIG. 13 Functional Configuration Example of Data Conversion Apparatus 100

FIG. 13 is a block diagram showing a functional configuration example of the data conversion apparatus 100 according to the second embodiment. The data conversion apparatus 100 includes the input question structuring unit 201, the question format conversion unit 202, the completion question output unit 203, a generated score calculation unit 1301, and a metric calculation unit 1302. Specifically, for example, the generated score calculation unit 1301 and the metric calculation unit 1302 are functions implemented by causing the processor 101 to execute a program stored in the storage device 102 shown in FIG. 1.

The generated score calculation unit 1301 receives the end completion question data 1200 and calculates, for each piece of end completion question data 1200, a generated score indicating plausibility of generation of the end completion question data 1200. Specifically, for example, the generated score calculation unit 1301 receives the end completion question data 1200 and calculates likelihood for each option 903.

The metric calculation unit 1302 calculates an evaluation metric for one or more pieces of input question data 400 as a whole based on the end completion question data 1200 related to each piece of input question data 400 and the generated score for the end completion question data 1200.

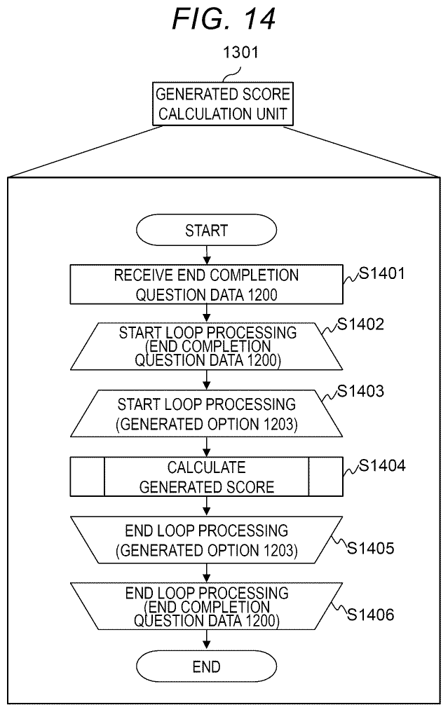

### FIG. 14 Generated Score Calculation Processing

FIG. 14 is a flowchart showing a detailed processing procedure example of generated score calculation processing by the generated score calculation unit 1301.

### Step S1401

The generated score calculation unit 1301 receives input of the end completion question data 1200 from the completion question output unit 112.

### Step S1402

The generated score calculation unit 1301 starts loop processing of the end completion question data 1200. Specifically, for example, the generated score calculation unit 1301 selects unselected end completion question data 1200. The end completion question data 1200 that is selected is referred to as the selected end completion question data 1200.

### Step S1403

The generated score calculation unit 1301 starts loop processing of the generated option 1203 for the selected end completion question data 1200 (step S1403). Specifically, for example, the generated score calculation unit 1301 selects an unselected generated option 1203. The generated option 1203 that is selected is referred to as the selected generated option 1203.

### Step S1404

The generated score calculation unit 1301 receives the generated context 1202 and the selected generated option 1203 of the selected end completion question data 1200, and calculates likelihood of the selected generated option 1203.

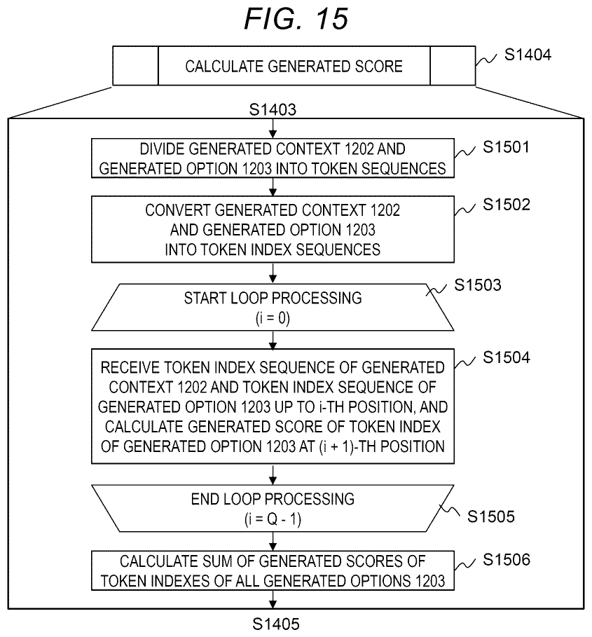

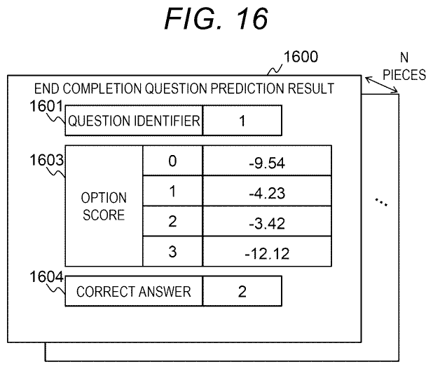

FIGS. 15 and 16 Generated Score Calculation (step S1404)

FIG. 15 is a flowchart showing a detailed processing procedure example of generated score calculation (step S1404) according to the second embodiment. FIG. 16 shows an example of an end completion question prediction result. An end completion question prediction result 1600 includes a question identifier 1601, an option score 1603, and a correct answer 1604.

The value of the question identifier 501 is stored in the question identifier 1601. The option score 1603 is calculated for each generated option (0 to 3). A generated option having a maximum value of the option score 1603 is stored in the correct answer 1604.

### Step S1501

The generated score calculation unit 1301 divides the generated context 1202 and the selected generated option 1203 of the selected end completion question data 1200 into a token sequence of the generated context 1202 and a token sequence of the generated option 1203, each of which includes one or more tokens, respectively. In this processing, the division into the token sequences may be based on a criterion different from that in step S901.

### Step S1502

Referring to the token dictionary 1000, the generated score calculation unit 1301 converts the token sequence of the generated context 1202 and the token sequence of the generated option 1203 into a token index sequence {t₀, t₁, . . . , t(P−1)} of the generated context 1202 including P integers and a token index sequence {x₀, x₁, . . . , x(Q−1)} of the generated option 1203 including Q integers, respectively. This conversion is the same as in step S902, but a token dictionary 1000 different from that in step S902 may be used.

### Step S1503

The generated score calculation unit 1301 starts the loop processing of the variable i. The variable i is set to i=0 as an initial value.

### Step S1504

The generated score calculation unit 1301 receives the token index sequence of the generated context 1202 and the token index sequence of the generated option 1203 up to an (i−1)-th token index, using a probability distribution model for a token index sequence such as GPT-3, and calculates a generated score lnp(xi|θ, t₀, t₁, . . . , tₚ, x₀, x₁, . . . , xᵢ₋₁) of the token index xi of an i-th generated option 1203.

Here, θ is a setting value (parameter) of the probability distribution model. The calculated generated score may not be a natural logarithm of a generated probability value, and may be a logarithm of the generated probability value with any base, the probability value, a reciprocal of the probability value, a score that does not satisfy a probability distribution requirement obtained by applying any correction to the probability value, or the like.

### Step S1505

The generated score calculation unit 1301 determines whether the i-th generated token index has the document variable i being a value obtained by subtracting 1 from the length Q of the generated option token index sequence.

When it is determined that the variable i is not the value obtained by subtracting 1 from the length Q of the token index sequence of the generated option 1203, the generated score calculation unit 1301 increments the variable i, returns to step S1504, and performs the same processing. When it is determined that the variable i is the value obtained by subtracting 1 from the length Q of the token index sequence of the generated option 1203, the generated score calculation unit 1301 ends the loop processing of the variable i, and the processing proceeds to step S1506.

### Step S1506

The generated score calculation unit 1301 calculates a sum of generated scores calculated in step S1504 and stores the sum as the option score 1603 corresponding to the selected generated option 1203. Specifically, a value y_{i,k} of the option score 1603 is calculated using the following formula (1).

$$\begin{matrix}Math . 1 Formula ( 1 ) & \\ & ( 1 )\end{matrix}$$

$${y}_{1 , k} = {\sum }_{i = 0}^{i = Q - 1} ln p ( {x}_{i} \vert θ , {t}_{0} , {t}_{1} , … , {t}_{p} , {x}_{0} , {x}_{1} , … , {x}_{i - 1} )$$

Here, j(0≥j<N) is an index of the end completion question data 1200, and k is an index of the generated option 1203. Instead of the sum of the generated scores, a score obtained by adding any correction, such as a value normalized by likelihood of how easily the generated option 1203 can be generated as in the following formula (2), may be used.

$$\begin{matrix}Math . 2 Formula ( 2 ) & \\ & ( 2 )\end{matrix}$$

$${y}_{j , k} = \frac{{\sum }_{i = 0}^{i = Q - 1} ln p ( {x}_{i} \vert θ , {t}_{0} , {t}_{1} , … , {t}_{p} , {x}_{0} , {x}_{1} , … , {x}_{i - 1} )}{{\sum }_{i = 0}^{i = Q - 1} ln p ( {x}_{i} \vert θ {,}_{1} , … , {x}_{i - 1} )}$$

Accordingly, the generated score calculation (step S1404) ends, and the processing proceeds to step S1405.

Instead of performing the generated score calculation (step S1404) by the data conversion apparatus 100, the data conversion apparatus 100 may transmit the selected end completion question data 1200 to a language model implemented on an external computer.

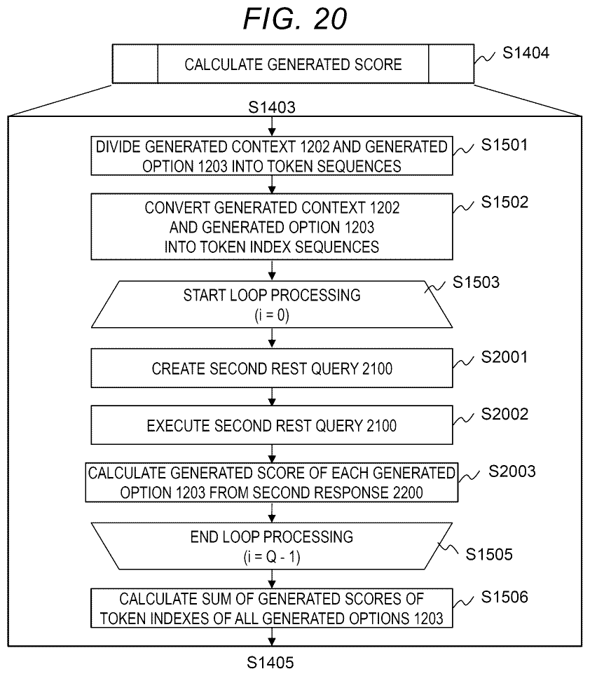

In this case, the language model implemented on the external computer performs the processing shown in FIG. 14 to calculate the sum of the generated scores for the selected end completion question data 1200. Then, the data conversion apparatus 100 receives the sum of the generated scores calculated by the language model implemented on the external computer (the same applies to FIG. 20 to be described later).

### Step S1405

Referring back to FIG. 14, the generated score calculation unit 1301 determines whether there is an unselected generated option 1203 in the selected end completion question data 1200 (step S1405).

When it is determined that there is at least one unselected generated option 1203, the generated score calculation unit 1301 returns to step S1404 and performs the same processing.

When it is determined that there is no unselected generated option 1203, the generated score calculation unit 1301 ends the loop processing of the generated option 1203, and the processing proceeds to step S1406.

### Step S1406

The generated score calculation unit 1301 determines whether there is unselected end completion question data 1200. When it is determined that there is at least one piece of unselected end completion question data 1200, the generated score calculation unit 1301 returns to step S1403 and performs the same processing. When it is determined that there is no unselected end completion question data 1200, the generated score calculation unit 1301 ends the loop processing of the end completion question data 1200 and ends the processing of the generated score calculation unit 1301.

Thereafter, the metric calculation unit 1302 calculates a performance of the probability distribution model for one or more pieces of input question data 400 as a whole based on the end completion question data 1200 related to each piece of input question data 400 and the generated score for the end completion question data 1200.

Accuracy of the probability distribution model is calculated using the following formula (3) using the option score 1603 (y_{j,k}), the correct answer 1604 (zⱼ), and the number of pieces N of the end completion question data 1200.

$$\begin{matrix}Math . 3 Formula ( 3 ) & \\ & ( 3 )\end{matrix}$$

$$( 1 / N ) {\sum }_{j = 0}^{j = N - 1} [ arg {max}_{k} ( {y}_{j , k} ) = {z}_{j} ]$$

Here, 1[ ] on a right side in formula (3) is a function that becomes “1” when a condition of an argument is satisfied and becomes “0” when the condition of the argument is not satisfied.

Mean average precision of the probability distribution model is calculated using the following formula (4) using the option score 1603 (y_{j,k}), the correct answer 1604 (zⱼ), and the number of pieces N of the end completion question data 1200.

$$\begin{matrix}Math . 4 Formula ( 4 ) & \\ & ( 4 )\end{matrix}$$

$$( 1 / N ) {\sum }_{j = 0}^{j = N - 1} [ 1 / {{rankz}_{j} ( {y}_{j , k} )}_{k} ]$$

Here, rank[ ] on a right side in formula (4) is a function representing a rank of the element i when a set of arguments is sorted in descending order.

The metric calculation unit 1302 may calculate, instead of or in addition to the accuracy in formula (3) and the mean average precision in formula (4), precision, recall, ROC-AUC, and the like. In the second embodiment, a case where there is one correct answer is shown, and it will be easily understood by those skilled in the art that the same procedure can also be applied to a multiple-choice question with zero or more correct answers.

According to the second embodiment, the data conversion apparatus 100 constructs data suitable for language model evaluation from the existing evaluation test for humans and evaluates the language model, thereby enabling standalone evaluation of the language model without the need to manually create evaluation data exclusively for the language model.

### Third Embodiment

In a third embodiment, processing of receiving the set of four-option questions in English as in the second embodiment and converting the set of questions into end completion questions suitable for evaluating the language model is described as an example. In the third embodiment, an example will be described in which the data conversion apparatus 100 generates text and calculates a generated score using an external computation service instead of generating the text and calculating the generated score with the question format conversion unit 202 and the generated score calculation unit 1301, respectively. In the third embodiment, differences from the first embodiment and the second embodiment will be mainly described, and thus descriptions of the same parts as those in the first embodiment and the second embodiment will be omitted.

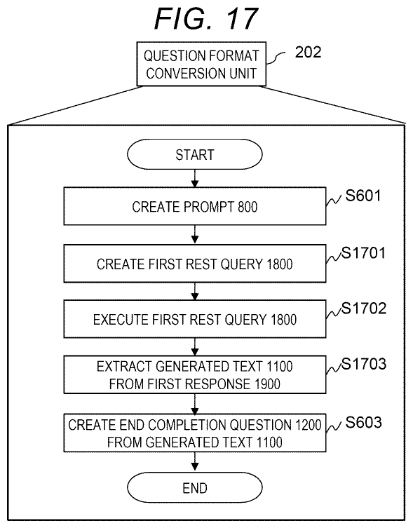

### FIGS. 17 to 19 Question Format Conversion Processing

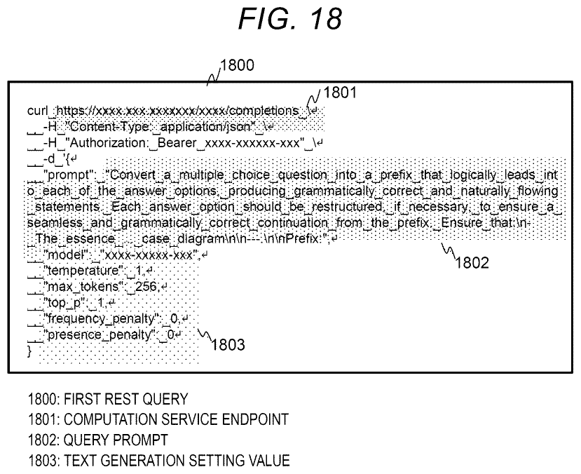

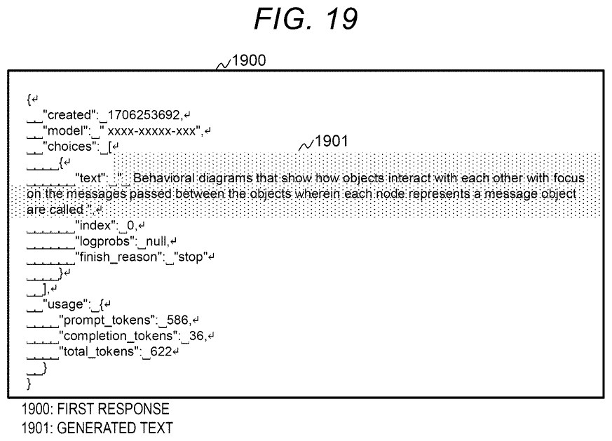

FIG. 17 is a flowchart showing a procedure example of question format conversion processing by the question format conversion unit 202 according to the third embodiment. FIG. 18 shows an example of a first REST query. FIG. 19 shows an example of a first response.

### Step S1701

The question format conversion unit 202 creates a first REST query 1800 based on the prompt 800 created in step S601. The question format conversion unit 202 performs JSON escaping on the prompt 800 and inserts the escaped prompt 800 into a query prompt 1802. The first REST query 1800 includes an external computation service endpoint 1801 for generating text and a text generation setting value 1803.

As the external computation service, OpenAI API, Anthropic Claude, or the like may be used, and other services or a compatible service set up by an implementer on an intranet may also be used. As communication methods, different methods such as Remote Procedure Call (RPC) and GraphQL may be used.

### Step S1702

The question format conversion unit 202 executes the first REST query 1800. Specifically, for example, the question format conversion unit 202 transmits the first REST query 1800 to the external computation service and acquires a first response 1900 from the external computation service.

### Step S1703

The question format conversion unit 202 extracts generated text 1901 from the first response 1900. Then, the processing proceeds to step S603.

### FIGS. 20 to 22 Generated Score Calculation (Step S1404)

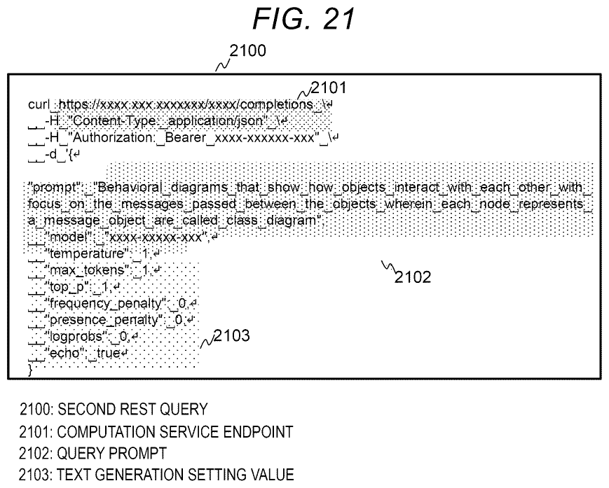

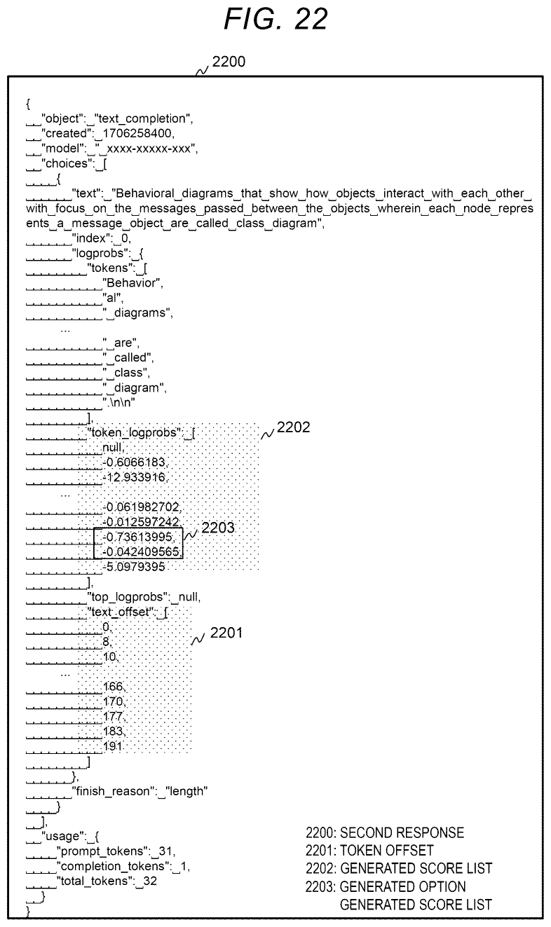

FIG. 20 is a flowchart showing a detailed processing procedure example of generated score calculation (step S1404) according to the third embodiment. FIG. 21 shows an example of a second REST query. FIG. 22 shows an example of a second response.

### Step S2001

The generated score calculation unit 1301 creates a second REST query 2100 based on the selected end completion question data 1200. The question format conversion unit 202 concatenates the generated context 1202 and the selected generated option 1203 in the selected end completion question data 1200 with a space, performs JSON escaping, and inserts, to a query prompt 2102, concatenated data obtained by concatenating the generated context 1202 and the selected generated option 1203 in the selected end completion question data 1200 with the space and performing the JSON escaping.

The second REST query 2100 includes an external computation service endpoint 2101 for generating text. In order to obtain the score, for example, in the case of OpenAI API, the generated score calculation unit 1301 sets a text generation setting value 2103 such that max_tokens is “1”, logprobs is “0”, and echo is “true”. Similarly to the question format conversion unit 202, various external computation services and communication methods may be used, and an external computation service or a communication method different from that of the question format conversion unit 202 may be used.

### Step S2002

The generated score calculation unit 1301 executes the second REST query 2100. Specifically, for example, the generated score calculation unit 1301 transmits the second REST query 2100 to the external computation service and acquires a second response 2200 from the external computation service.

### Step S2003

The generated score calculation unit 1301 calculates the generated score of the selected generated option 1203 based on the second response 2200. In order to extract the generated score corresponding to the selected generated option 1203, the generated score calculation unit 1301 obtains a count of numbers in a token offset 2201 equal to or more than the number of characters in the generated context 1202 and excluding an item specified by max_tokens in the text generation setting value 2103 from the end.

The generated score calculation unit 1301 extracts a numerical value corresponding to this count from a generated score list 2202 as a generated option generated score list 2203, and outputs a sum of the generated option generated score list 2203 as the generated score. Thereafter, the processing proceeds to step S1505.

According to the third embodiment, the data conversion apparatus 100 enables the standalone evaluation of the language model without performing processing with high computation cost internally. In addition, the data conversion apparatus 100 can evaluate a language model implemented as an external computer.

### Fourth Embodiment

In a fourth embodiment, processing of receiving the set of four-option questions in English as in the first embodiment and converting the set of questions into end completion questions suitable for evaluating the language model is described as an example. In the fourth embodiment, an example will be described in which, when text is generated by the data conversion apparatus 100 in the question format conversion unit 202, conversion is performed based on a syntax tree and a rule of evaluation data instead of directly generating text with the probability distribution model. In the fourth embodiment, differences from the first embodiment to the third embodiment will be mainly described, and thus descriptions of the same parts as those in the first embodiment to the third embodiment will be omitted.

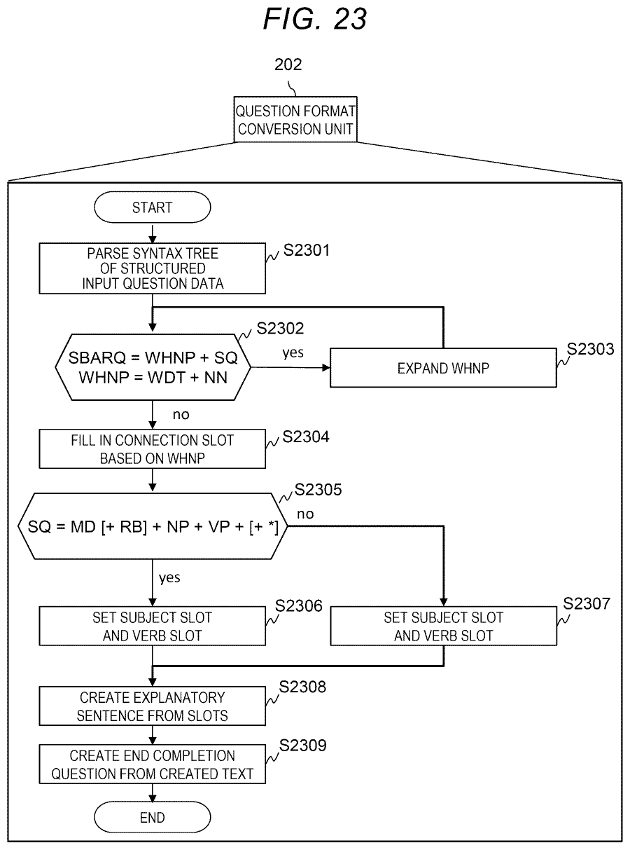

### FIGS. 23 to 25 Question Format Conversion Processing

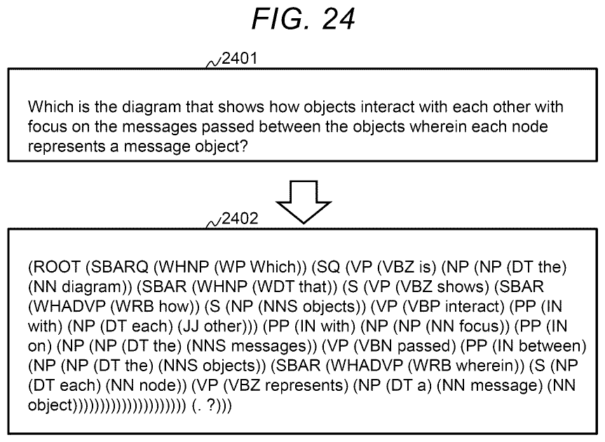

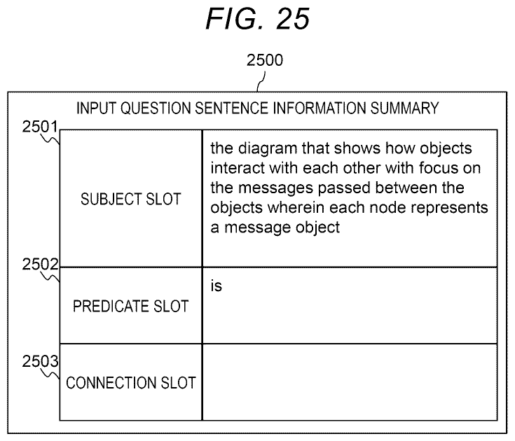

FIG. 23 is a flowchart showing a procedure example of question format conversion processing by the question format conversion unit 202 according to the fourth embodiment. FIG. 24 shows an example of syntactic parsing. FIG. 24 shows an input sentence 2401 and a syntax tree 2402. FIG. 25 shows an example of an input question sentence information summary.

An input question sentence information summary 2500 includes a subject slot 2501, a predicate slot 2502, and a connection slot 2503. The subject slot 2501, the predicate slot 2502, and the connection slot 2503 are blank in an initial setting. Hereinafter, FIG. 23 will be described.

### Step S2301

The question format conversion unit 202 performs syntactic parsing on the question text 502. In the fourth embodiment, an example is shown in which constituency parsing in a Penn Treebank format is performed on a question sentence in English. In particular, a case where Stanford CoreNLP is used as a parser is assumed, the following part-of-speech tag notation conforms to Stanford CoreNLP notation. It will be easily understood by those skilled in the art that the question format can be converted according to the fourth embodiment even when the syntactic parsing is performed on a grammar other than English, when dependency parsing is used instead of constituency parsing, when a grammar other than Penn Treebank is used, or when a parser other than Stanford CoreNLP is used.

For example, when the question text 502 as shown in the input sentence 2401 is received by a syntactic parser, the syntactic parser outputs the syntax tree 2402. In the fourth embodiment, it is assumed that a sentence is a 5W1H question sentence typical in terms of a four-option question and has SBARQ (a direct doubt introduced by a wh-word or a wh-phrase) as null constituents.

A main clause of SBARQ includes a Wh-adverb phrase (WHADVP) or a Wh-noun phrase (WHNP), and an SQ (an SBARQ subordinate component excluding the wh-word or the wh-phrase).

### Step S2302

The question format conversion unit 202 determines whether SBARQ=WHNP+SQ and WHNP=WDT (wh-determiner)+NN (noun). This condition is satisfied, for example, by “What components stopped network?”, and a syntax tree thereof is
(SBARQ (WHNP (WDT What) (NN component)) (SQ (VP (VBD stopped) (NP (NN network)))) (.?)).

When this condition is satisfied, the processing proceeds to step S2303. When this condition is not satisfied, the processing proceeds to step S2304.

### Step S2303

When WHNP includes NN (noun), the question format conversion unit 202 replaces WHNP with WDT (wh-determiner)+be verb+the +NN+that. At this time, the be verb is determined to be “is” or “are” based on whether NN (noun) is singular or plural.

Whether NN (noun) is singular or plural is determined by referring to a dictionary (not shown) prepared in advance. That is, “What components stopped network?” is converted into “What are the components that stopped network?”.

### Step S2304

The question format conversion unit 202 sets a connection slot 2133 based on a head (main part) of WHNP (wh-noun phrase) (step S2304). When the head of WHNP is “why”, “because” is set, when the head is “how”, “by” is set, otherwise the connection slot 2133 is blank.

### Step S2305

The question format conversion unit 202 determines whether the syntax tree 2402 includes a modal auxiliary verb, that is, whether
SQ=MD [+RB]+NP [+RB]+VP [+*](step S2305). Here, MD is a modal auxiliary verb, RB is an adverb, NP is a noun phrase, VP is a verb phrase, [+X] is presence of X as a non-essential constituent element, and [+*] is presence of any number of any constituent element.

An example of the syntax tree 2402 matching this condition is
(SBARQ (WHADVP (WRB How)) (SQ (MD can) (NP (PRP I)) (VP (VB reset) (NP (NN network)))) (.?)).

When this condition is satisfied, the processing proceeds to step S2306. When this condition is not satisfied, the processing proceeds to step S2307.

### Step S2306

The question format conversion unit 202 sets a subject slot 2131 and a predicate slot 2132 based on a value of SQ. Specifically, for example, the question format conversion unit 202
stores NP (noun phrase) in the subject slot 2131 and MD [+RB]+VP [+*] in the predicate slot 2132 for

$$SQ = MD [ \begin{matrix}+ & RB ] + NP + VP [ \begin{matrix}+ & *\end{matrix} ] .\end{matrix}$$

For example, for “How can I reset network” described above, “I” is stored in the subject slot 2131 and “can reset network” is stored in the predicate slot 2132.

### Step S2307

The question format conversion unit 202 sets the subject slot 2131 and the predicate slot 2132 based on the value of SQ. Specifically, for example, the question format conversion unit 202
stores [+*] in the subject slot 2131 and stores VP [+RB] in the predicate slot 2132 for

$$SQ = VP [ \begin{matrix}+ & RB ] + NP [ \begin{matrix}+ & *\end{matrix} ] .\end{matrix}$$

For example, “the components that stopped network” is stored in the subject slot 2131 and “are” is stored in the predicate slot 2132 for the syntax tree 2402 (SBARQ (WHNP (WP What)) (SQ (VP (VBP are) (NP (NP (DT the) (NNS components)) (SBAR (WHNP (WDT that)) (S (VP (VBD stopped) (NP (NN network)))))))) (.?)).

For “Why isn't network stopped?”, “network” is stored in the subject slot 2131 and “isn't stopped” is stored in the predicate slot 2132.

For “How did network stop?”, “network” is stored in the subject slot 2131 and “did stop” is stored in the predicate slot 2132.

### Step S2308

The question format conversion unit 202 creates an explanatory sentence in an end completion format based on the subject slot 2131, the predicate slot 2132, and the connection slot 2133. A first character of the subject slot 2131 is converted to uppercase and combined with the predicate slot 2132 and the connection slot 2133 with a space therebetween to create an explanatory sentence.

For example, for the input sentence 2401 shown in FIG. 24, that is,
“Which is the diagram that shows how objects interact with each other with focus on the messages passed between the objects wherein each node represents a message object?”,
an explanatory sentence in an end completion format such as
“The diagram that shows how objects interact with each other with focus on the messages passed between the objects wherein each node represents a message object is” is created.

The question format conversion unit 202 described in the fourth embodiment does not have a function of converting all questions into the explanatory sentence in the end completion format. For example, according to the processing described above, a question “What causes network delay?” is converted into “Network delay causes”, and thus an original intent of the question is lost.

However, generally, an evaluation test for humans tends to be consistently written in a controlled language for each evaluation test, and thus no significant practical issue will be caused by providing exception processing for each evaluation test.

### Step S2309

The question format conversion unit 202 creates the end completion question data 1200 based on the created question sentence in the end completion format. Specifically, the question format conversion unit 202 inserts the created text into the generated context 1202 in the end completion question data 1200. For example, the question format conversion unit 202 inserts the question identifier 501 in the structured input question data 500 into a question identifier 901, and inserts the correct answer 504 into a correct answer 904. Accordingly, the question format conversion processing ends.

According to the fourth embodiment, the data conversion apparatus 100 enables the standalone evaluation of the language model without performing processing with the probability distribution model having high computation cost. Since the data conversion apparatus 100 is constructed around a deterministic rule, quality management and issue resolution are facilitated.

As described above, according to the first to fourth embodiments, it is possible to optimize the format of the question sentence for an evaluation target such as the language model. Specifically, for example, by converting the question sentence used in the existing evaluation test for humans into the question sentence in the format suitable for evaluating the language model, a standalone evaluation of the language model can be performed without manually creating the question sentence in the format suitable for language model evaluation. Accordingly, it is possible to reduce workload and optimize the evaluation for the language model.

The invention is not limited to the above embodiments, and includes various modifications and equivalent configurations within the scope of the appended claims. For example, the above embodiments are described in detail for easy understanding of the invention, and the invention is not necessarily limited to those including all the configurations described above. A part of a configuration of one embodiment may be replaced with a configuration of another embodiment. A configuration of one embodiment may also be added to a configuration of another embodiment. Another configuration may be added to a part of a configuration of each embodiment, and a part of the configuration of each embodiment may be deleted or replaced with another configuration.

A part or all of the above configurations, functions, processing units, processing methods, and the like may be implemented by hardware by, for example, designing with an integrated circuit, or may be implemented by software by, for example, a processor interpreting and executing a program for implementing each function.

Information in a program, a table, a file, or the like for implementing each function can be stored in a storage apparatus such as a memory, a hard disk, or a solid state drive (SSD), or in a recording medium such as an integrated circuit (IC) card, an SD card, or a digital versatile disc (DVD).

Control lines and information lines considered to be necessary for descriptions are shown, and not all control lines and information lines necessary for implementation are shown. Actually, it may be considered that almost all the configurations are connected to one another.

What is claimed is:

1. A data conversion apparatus comprising:
a processor configured to execute a program; and
a storage device configured to store the program, wherein
the processor performs
input processing of receiving a plurality of options and a first question sentence where one of the plurality of options is a correct answer,
conversion processing of converting, based on the plurality of options and the first question sentence received by the input processing, the first question sentence into a second question sentence in a format different from a format of the first question sentence, and
output processing of outputting the second question sentence converted by the conversion processing and the plurality of options.

2. The data conversion apparatus according to claim 1, wherein
the second question sentence is an explanatory sentence in a completion format with a missing part to be completed by filling in the correct answer.

3. The data conversion apparatus according to claim 1, wherein
the first question sentence is an interrogative sentence that asks which of the plurality of options is the correct answer.

4. The data conversion apparatus according to claim 1, wherein
the first question sentence is a declarative sentence that expresses the correct answer by a demonstrative pronoun.

5. The data conversion apparatus according to claim 1, wherein
in the conversion processing, the processor generates the second question sentence by performing prediction processing of predicting a next word in a word sequence from a beginning in the first question sentence.

6. The data conversion apparatus according to claim 1, wherein
the data conversion apparatus is accessible to a computer that implements a language model for predicting a next word in a word sequence, and
in the conversion processing, the processor receives the second question sentence generated by the computer as a result of transmitting the first question sentence to the computer.

7. The data conversion apparatus according to claim 1, wherein
the processor performs acquisition processing of acquiring, based on a word sequence in the second question sentence and a word sequence in the options, a score indicating plausibility of generation of the second question sentence for each of the options, and
in the output processing, the processor outputs the score acquired by the acquisition processing for each of the options.

8. The data conversion apparatus according to claim 7, wherein
the data conversion apparatus is accessible to a computer that implements a language model for predicting, based on a word sequence in a question and a word sequence in an answer to the question, plausibility of the answer given that the question is generated, and
in the acquisition processing, the processor acquires, for each of the options, a score indicating plausibility of the options calculated by the computer given that the second question sentence is generated as a result of transmitting the word sequence in the second question sentence and the word sequence in the options to the computer.

9. The data conversion apparatus according to claim 7, wherein
the processor performs calculation processing of calculating, based on the score, a metric value indicating a performance of the language model with respect to the second question sentence.

10. The data conversion apparatus according to claim 1, wherein
in the conversion processing, the processor generates the second question sentence by analyzing a syntax tree of the first question sentence, matching each subtree of the syntax tree to a predetermined rule, rearranging an order of words in the first question sentence based on an operation method associated with the matched rule, and supplementing with a predetermined word.

11. A data conversion method performed by a data conversion apparatus including a processor that executes a program and a storage device that stores the program, the method comprising:
causing the processor to perform
input processing of receiving a plurality of options and a first question sentence where one of the plurality of options is a correct answer,
conversion processing of converting, based on the plurality of options and the first question sentence received by the input processing, the first question sentence into a second question sentence in a format different from a format of the first question sentence, and
output processing of outputting the second question sentence converted by the conversion processing and the plurality of options.

12. A data conversion program that causes a processor to perform
input processing of receiving a plurality of options and a first question sentence where one of the plurality of options is a correct answer,
conversion processing of converting, based on the plurality of options and the first question sentence received by the input processing, the first question sentence into a second question sentence in a format different from a format of the first question sentence, and
output processing of outputting the second question sentence converted by the conversion processing and the plurality of options.
